(19) United States
(12) Patent Application Publication
(10) Pub. No.: US 2013/0339972 A1
(43) Pub. Date: Dec. 19, 2013

(54) DETERMINING AN ALLOCATION OF RESOURCES TO A PROGRAM HAVING CONCURRENT JOBS

(71) Applicants: Zhuoyao Zhang, Philadelphia, PA (US); Abhishek Verma, Champaign, IL (US); Ludmila Cherkasova, Sunnyvale, CA (US)

(72) Inventors: Zhuoyao Zhang, Philadelphia, PA (US); Abhishek Verma, Champaign, IL (US); Ludmila Cherkasova, Sunnyvale, CA (US)

(21) Appl. No.: 13/525,820

(22) Filed: Jun. 18, 2012

(51) Int. Cl. G06F 9/50

(52) U.S. Cl. 718/104

(57) ABSTRACT

A performance model for a collection of jobs that make up a program is used to calculate a performance parameter based on a number of map tasks in the jobs, a number of reduce tasks in the jobs, and an allocation of resources, where the jobs include the map tasks and the reduce tasks, the map tasks producing intermediate results based on segments of input data, and the reduce tasks producing an output based on the intermediate results. The performance model considers overlap of concurrent jobs. Using a value of the performance parameter calculated by the performance model, a particular allocation of resources is determined to assign to the jobs of the program to meet a performance goal of the program.

### BACKGROUND

Computing services can be provided by a network of resources, which can include processing resources and storage resources. The network of resources can be accessed by various requestors. In an environment that can have a relatively large number of requestors, there can be competition for the resources.

### BRIEF DESCRIPTION OF THE DRAWINGS

Some embodiments are described with respect to the following figures:

FIG. 1 is a block diagram of an example arrangement that incorporates some implementations;

FIG. 2 is a graph of an example arrangement of jobs, for which resource allocation is to be performed according to some implementations;

FIG. 3 is a flow diagram of a resource allocation process according to some implementations;

FIGS. 4A-4B, 5A-5B, and 6A-6B illustrate various examples of executions of jobs; and

FIG. 7 illustrates determination of a given allocation of map slots and reduce slots from feasible solutions representing respective allocations of map slots and reduce slots, determined according to some implementations.

### DETAILED DESCRIPTION

To process data sets in a network environment that includes computing and storage resources, a MapReduce framework can be used, where the MapReduce framework provides a distributed arrangement of machines to process requests performed with respect to the data sets. A MapReduce framework is able to process unstructured data, which refers to data not formatted according to a format of a relational database management system. An example open-source implementation of the MapReduce framework is Hadoop.

Generally, a MapReduce framework includes a master node and multiple slave nodes (also referred to as worker nodes). A MapReduce job submitted to the master node is divided into multiple map tasks and multiple reduce tasks, which can be executed in parallel by the slave nodes. The map tasks are defined by a map function, while the reduce tasks are defined by a reduce function. Each of the map and reduce functions can be user-defined functions that are programmable to perform target functionalities. A MapReduce job thus has a map stage (that includes map tasks) and a reduce stage (that includes reduce tasks).

MapReduce jobs can be submitted to the master node by various requestors. In a relatively large network environment, there can be a relatively large number of requestors that are contending for resources of the network environment. Examples of network environments include cloud environments, enterprise environments, and so forth. A cloud environment provides resources that are accessible by requestors over a cloud (a collection of one or multiple networks, such as public networks). An enterprise environment provides resources that are accessible by requestors within an enterprise, such as a business concern, an educational organization, a government agency, and so forth.

Although reference is made to a MapReduce framework or system in some examples, it is noted that techniques or mechanisms according to some implementations can be applied in other distributed processing frameworks that employ map tasks and reduce tasks. More generally, “map tasks” are used to process input data to output intermediate results, based on a predefined map function that defines the processing to be performed by the map tasks. “Reduce tasks” take as input partitions of the intermediate results to produce outputs, based on a predefined reduce function that defines the processing to be performed by the reduce tasks. The map tasks are considered to be part of a map stage, whereas the reduce tasks are considered to be part of a reduce stage. In addition, although reference is made to unstructured data in some examples, techniques or mechanisms according to some implementations can also be applied to structured data formatted for relational database management systems.

Map tasks are run in map slots of slave nodes, while reduce tasks are run in reduce slots of slave nodes. The map slots and reduce slots are considered the resources used for performing map and reduce tasks. A “slot” can refer to a time slot or alternatively, to some other share of a processing resource or storage resource that can be used for performing the respective map or reduce task.

More specifically, in some examples, the map tasks process input key-value pairs to generate a set of intermediate key-value pairs. The reduce tasks (based on the reduce function) produce an output from the intermediate results. For example, the reduce tasks merge the intermediate values associated with the same intermediate key.

The map function takes input key-value pairs (k₁, v₁) and produces a list of intermediate key-value pairs (k₂, v₂). The intermediate values associated with the same key k₂ are grouped together and then passed to the reduce function. The reduce function takes an intermediate key k₂ with a list of values and processes them to form a new list of values (v₃), as expressed below.

map(k₁,v₁)→list(k₂,v₂)

reduce(k₂,list(v₂))→list(v₃).

The reduce function merges or aggregates the values associated with the same key k₂. The multiple map tasks and multiple reduce tasks (of multiple jobs) are designed to be executed in parallel across resources of a distributed computing platform.

In a relatively complex or large system, it can be relatively difficult to efficiently allocate resources to jobs and to schedule the tasks of the jobs for execution using the allocated resources.

In a network environment that provides services accessible by requestors, it may be desirable to support a performance-driven resource allocation of network resources shared across multiple requestors running data-intensive programs. A program to be run in a MapReduce system may have a performance goal, such as a completion time goal, cost goal, or other goal, by which results of the program are to be provided to satisfy a service level objective (SLO) of the program.

In some examples, the programs to be executed in a MapReduce system can include Pig programs. Pig provides a high-level platform for creating MapReduce programs. In some examples, the language for the Pig platform is referred to as Pig Latin, where Pig Latin provides a declarative language to allow for a programmer to write programs using a high-level programming language. Pig Latin combines the high-level declarative style of SQL (Structured Query Language) and the low-level procedural programming of MapReduce. The declarative language can be used for defining data analysis tasks. By allowing programmers to use a declarative programming language to define data analysis tasks, the programmer does not have to be concerned with defining map functions and reduce functions to perform the data analysis tasks, which can be relatively complex and time-consuming.

Although reference is made to Pig programs, it is noted that in other examples, programs according to other declarative languages can be used to define data analysis tasks to be performed in a MapReduce system.

In accordance with some implementations, mechanisms or techniques are provided to specify efficient allocations of resources in a MapReduce system to jobs of a program, such as a Pig program or other program written in a declarative language. In the ensuing discussion, reference is made to Pig programs—however, techniques or mechanisms according to some implementations can be applied to programs according to other declarative languages.

Given a Pig program with a given performance goal, such as a completion time goal, cost goal, or other goal, techniques or mechanisms according to some implementations are able to estimate an amount of resources (a number of map slots and a number of reduce slots) to assign for completing the Pig program according to the given performance goal. The allocated number of map slots and number of reduce slots can then be used by the jobs of the Pig program for the duration of the execution of the Pig program.

To perform the resource allocation, a performance model can be developed to allow for the estimation of a performance parameter, such as a completion time or other parameter, of a Pig program as a function of allocated resources (allocated number of map slots and allocated number of reduce slots).

At least a subset of the jobs of the Pig program can execute concurrently. The performance model that can be developed according to some implementations takes into account overlap of the concurrent jobs. For example, given a pair of concurrent jobs, the reduce stage of a first concurrent job can overlap with the map stage of a second concurrent job—in other words, at least a portion of the reduce stage of the first concurrent job can run at the same time as at least a portion of the map stage of a second concurrent job. By taking into account overlap in execution of concurrent jobs, the performance model can provide a more accurate estimate of the performance parameter noted above, such as completion time or other parameter.

By considering overlap of execution of concurrent jobs, the performance parameter that is estimated can allow for more optimal resource allocation. For example, where the performance parameter is a completion time of a Pig program, the consideration of overlap of concurrent jobs in the performance model can allow for a smaller completion time to be estimated, as compared to an example where the jobs of a Pig program are soon to be sequential jobs where one job executes after completion of another job (which can lead to a worst-case estimate of the completion time).

To further enhance resource allocation, a more optimal schedule of concurrent jobs of the Pig program can be developed. This more optimal schedule of concurrent jobs of the Pig program attempts to specify an order of the concurrent jobs that results in a reduction of the overall completion time of the concurrent jobs.

More generally, techniques or mechanisms according to some implementations are able to perform the following:
Given a Pig program, estimate its completion time (or other performance parameter) as a function of allocated resources, using a performance model as discussed above; and
Given a Pig program with a completion time goal (or other performance parameter goal), estimate the amount of resources for completing the Pig program within a given deadline of the Pig program.

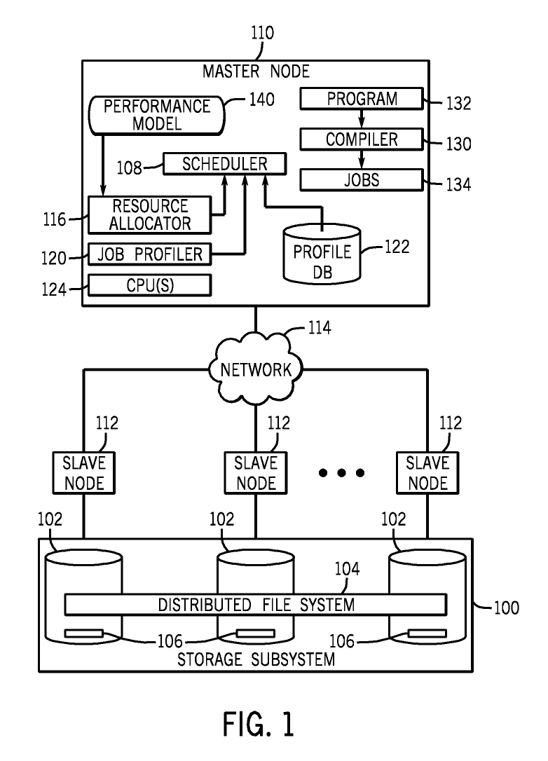

FIG. 1 illustrates an example arrangement that provides a distributed processing framework that includes mechanisms according to some implementations. As depicted in FIG. 1, a storage subsystem 100 includes multiple storage modules 102, where the multiple storage modules 102 can provide a distributed file system 104. The distributed file system 104 stores multiple segments 106 of data across the multiple storage modules 102. The distributed file system 104 can also store outputs of map and reduce tasks.

The storage modules 102 can be implemented with storage devices such as disk-based storage devices or integrated circuit or semiconductor storage devices. In some examples, the storage modules 102 correspond to respective different physical storage devices. In other examples, plural ones of the storage modules 102 can be implemented on one physical storage device, where the plural storage modules correspond to different logical partitions of the storage device.

The system of FIG. 1 further includes a master node 110 that is connected to slave nodes 112 over a network 114. The network 114 can be a private network (e.g. a local area network or wide area network) or a public network (e.g. the Internet), or some combination thereof. The master node 110 includes one or multiple central processing units (CPUs) 124. Each slave node 112 also includes one or multiple CPUs (not shown). Although the master node 110 is depicted as being separate from the slave nodes 112, it is noted that in alternative examples, the master node 112 can be one of the slave nodes 112.

A “node” refers generally to processing infrastructure to perform computing operations. A node can refer to a computer, or a system having multiple computers. Alternatively, a node can refer to a CPU within a computer. As yet another example, a node can refer to a processing core within a CPU that has multiple processing cores. More generally, the system can be considered to have multiple processors, where each processor can be a computer, a system having multiple computers, a CPU, a core of a CPU, or some other physical processing partition.

In accordance with some implementations, a scheduler 108 in the master node 110 is configured to perform scheduling of jobs on the slave nodes 112. The slave nodes 112 are considered the working nodes within the cluster that makes up the distributed processing environment.

Each slave node 112 has a corresponding number of map slots and reduce slots, where map tasks are run in respective map slots, and reduce tasks are run in respective reduce slots. The number of map slots and reduce slots within each slave node 112 can be preconfigured, such as by an administrator or by some other mechanism. The available map slots and reduce slots can be allocated to the jobs.

The slave nodes 112 can periodically (or repeatedly) send messages to the master node 110 to report the number of free slots and the progress of the tasks that are currently running in the corresponding slave nodes.

Each map task processes a logical segment of the input data that generally resides on a distributed file system, such as the distributed file system 104 shown in FIG. 1. The map task applies the map function on each data segment and buffers the resulting intermediate data. This intermediate data is partitioned for input to the reduce tasks.

The reduce stage (that includes the reduce tasks) has three phases: shuffle phase, sort phase, and reduce phase. In the shuffle phase, the reduce tasks fetch the intermediate data from the map tasks. In the sort phase, the intermediate data from the map tasks are sorted. An external merge sort is used in case the intermediate data does not fit in memory. Finally, in the reduce phase, the sorted intermediate data (in the form of a key and all its corresponding values, for example) is passed on the reduce function. The output from the reduce function is usually written back to the distributed file system 104.

As further shown in FIG. 1, the master node 110 includes a compiler 130 that is able to compile (translate or convert) a Pig program 132 into a collection 134 of MapReduce jobs. The Pig program 132 may have been provided to the master node 110 from another machine, such as a client machine (a requestor). As noted above, the Pig program 132 can be written in Pig Latin. A Pig program can specify a query execution plan that includes a sequence of steps, where each step specifies a corresponding data transformation task.

The master node 110 of FIG. 1 further includes a job profiler 120 that is able to create a job profile for each job in the collection 134 of jobs. A job profile describes characteristics of map and reduce tasks of the given job to be performed by the system of FIG. 1. A job profile created by the job profiler 120 can be stored in a job profile database 122. The job profile database 122 can store multiple job profiles, including job profiles of jobs that have executed in the past.

The master node 110 also includes a resource allocator 116 that is able to allocate resources, such as numbers of map slots and reduce slots, to jobs of the Pig program 132, given a performance goal (e.g. target completion time) associated with the Pig program 132. The resource allocator 116 receives as input jobs profiles of the jobs in the collection 134. The resource allocator 116 also uses a performance model 140 that calculates a performance parameter (e.g. time duration of a job) based on the characteristics of a job profile, a number of map tasks of the job, a number of reduce tasks of the job, and an allocation of resources (e.g. number of map slots and number of reduce slots).

Using the performance parameter calculated by the performance model 140, the resource allocator 116 is able to determine feasible allocations of resources to assign to the jobs of the Pig program 132 to meet the performance goal associated with the Pig program 132. As noted above, in some implementations, the performance goal is expressed as a target completion time, which can be a target deadline or a target time duration, by or within which the job is to be completed. In such implementations, the performance parameter that is calculated by the performance model 140 is a time duration value corresponding to the amount of time the jobs would take assuming a given allocation of resources. The resource allocator 116 is able to determine whether any particular allocation of resources can meet the performance goal associated with the Pig program 132 by comparing a value of the performance parameter calculated by the performance model to the performance goal.

The numbers of map slots and numbers of reduce slots allocated to respective jobs can be provided by the resource allocator 116 to the scheduler 108. The scheduler 108 is able to listen for events such as job submissions and heartbeats from the slave nodes 118 (indicating availability of map and/or reduce slots, and/or other events). The scheduling functionality of the scheduler 108 can be performed in response to detected events.

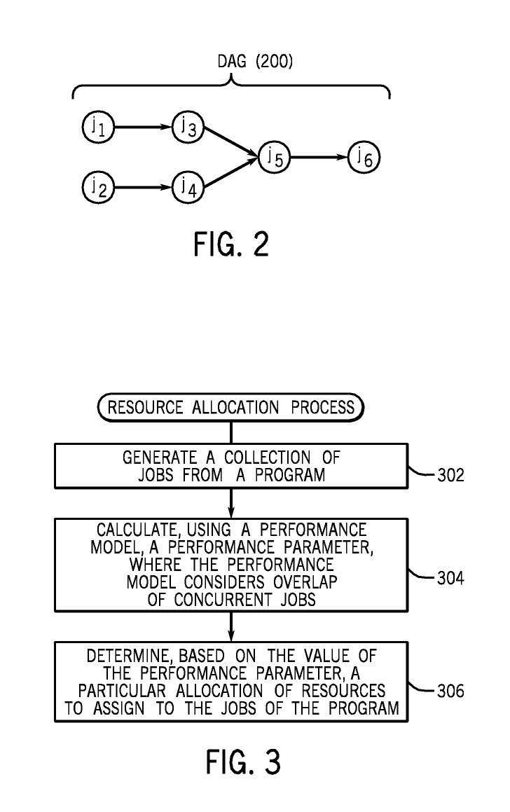

In some implementations, the collection 134 of jobs produced by the compiler 130 from the Pig program 132 can be a directed acyclic graph (DAG) of jobs. A DAG is a directed graph that is formed by a collection of vertices and directed edges, where each edge connects one vertex to another vertex. The DAG of jobs specify an ordered sequence, in which some jobs are to be performed earlier than other jobs, while certain jobs can be performed in parallel with certain other jobs. FIG. 2 shows an example DAG 200 of five MapReduce jobs {J₁,J₂,J₃,J₄,J₅}, where each vertex in the DAG 200 represents a corresponding MapReduce job, and the edges between the vertices represent the data dependencies between jobs.

To execute the plan represented by the DAG 200 of FIG. 2, the scheduler 108 can submit all the ready jobs (the jobs that do not have data dependency on other jobs) to the slave nodes. After the slave nodes have processed these jobs, the scheduler 108 can delete those jobs and the corresponding edges from the DAG, and can identify and submit the next set of ready jobs. This process continues until all the jobs are completed. In this way, the scheduler 108 partitions the DAG 200 into multiple job stages, each containing one or multiple independent MapReduce jobs that can be executed concurrently.

For example, the DAG 200 shown in FIG. 2 can be partitioned into the following four job stages for processing:

first job stage: {J₁,J₂};

second job stage: {J₃,J₄};

third job stage: {J₅};

fourth job stage: {J₆}.

In a given job stage that has multiple jobs, those multiple jobs can be considered concurrent jobs since they can be executed concurrently within the given job stage (before processing proceeds to the next job stage).

In other examples, instead of representing a collection of jobs as a DAG, the collection of jobs can be represented using another type of data structure that provides a representation of an ordered arrangement of jobs that make up a program.

FIG. 3 is a flow diagram of a resource allocation process according to some implementations, which can be performed by the master node 110 of FIG. 1, for example. The process includes generating (at 302) a collection of jobs from a program, such as the Pig program 132 of FIG. 1. The generating can be performed by the compiler 130 of FIG. 1. As noted above, the collection of jobs can be a DAG of jobs (e.g. 200 in FIG. 2). Each job of the collection can include a map stage (of map tasks) and a reduce stage (of reduce tasks).

The process calculates (at 304) a performance parameter using a performance model (e.g. 140 in FIG. 1) based on the characteristics of the jobs, a number of the map tasks in the jobs, a number of reduce tasks in the jobs, and an allocation of resources. The performance model considers overlap of concurrent jobs. For example, in the DAG 200 of FIG. 2, J₁ and J₂ can be considered concurrent jobs in the first job stage. Each of the concurrent jobs J₁ and J₂ has a map stage and a reduce stage. The map stage of job J₂ can begin execution upon completion of the map stage of the job J₁. As a result, the map stage of job J₂ can run at the same time as (can overlap) the reduce stage of job J₁.

The process then determines (at 306), based on the value of the performance parameter calculated by the performance model, a particular allocation of resources to assign to the jobs of the program to meet a performance goal of the program. Task 306 can be performed by the resource allocator 116.

Given the allocation of resources to assign to the jobs of the program, the scheduler 108 of FIG. 1 can schedule the jobs for execution on the slave nodes 112 of FIG. 1 (using available map and reduce slots of the slave nodes 112).

Further details of the performance model (e.g. 140 of FIG. 1) are provided below. In some implementations, the performance model evaluates lower, upper, or intermediate (e.g. average) bounds on a target completion time. The performance model can be based on a general model for computing performance bounds on the completion time of a given set of n (where n≧1) tasks that are processed by k (where k≧1) nodes, (e.g. n map or reduce tasks are processed by k map or reduce slots in a MapReduce environment). Let T₁, T₂, . . . , Tₙ be the duration of n tasks in a given set. Let k be the number of slots that can each execute one task at a time. The assignment of tasks to slots can be performed using an online, greedy techique: assign each task to the slot which finished its running task the earliest. Let avg and max be the average and maximum duration of the n tasks, respectively. Then the completion time of a task can be at least:

$${T}^{low} = avg \cdot \frac{n}{{k}^{′}}$$

and at most

$${T}^{up} = avg \cdot \frac{( n - 1 )}{k} + max .$$

The difference between lower and upper bounds represents the range of possible completion times due to task scheduling non-determinism (based on whether the maximum duration task is scheduled to run last). Note that these lower and upper bounds on the completion time can be computed if the average and maximum durations of the set of tasks and the number of allocated slots is known.

To approximate the overall completion time of a job J, the average and maximum task durations during different execution phases of the job are estimated. The phases include map, shuffle/sort, and reduce phases. Measurements such as M_{avg}^{J} and Mₘₐₓ^{J} (R_{avg}^{J} and Rₘₐₓ^{J}) of the average and maximum map (reduce) task durations for a job J can be obtained from execution logs (logs containing execution times of previously executed jobs). By applying the outlined bounds model, the completion times of different processing phases (map, shuffle/sort, and reduce phases) of the job are estimated.

For example, let job J be partitioned into N_{M}^{J} map tasks. Then the lower and upper bounds on the duration of the map stage in the future execution with S_{M}^{J} map slots (the lower and upper bounds are denoted as T_{M}^{low} and T_{M}^{up} respectively) are estimated as follows:

$$\begin{matrix}{T}_{M}^{low} = {M}_{avg}^{J} \cdot {N}_{M}^{J} / {S}_{M}^{J} , & ( Eq . 1 ) \\ {T}_{M}^{up} = {M}_{avg}^{J} \cdot \frac{{N}_{M}^{J} - 1}{{S}_{M}^{J}} + {M}_{ma x}^{J} . & ( Eq . 2 )\end{matrix}$$

Similarly, bounds of the execution time of other processing phases (shuffle/sort and reduce phases) of the job can be computed. As a result, the estimates for the entire job completion time (lower bound T_{J}^{low} and upper bound T_{J}^{up}) can be expressed as a function of allocated map and reduce slots (S_{M}^{J}, S_{R}^{J}) using the following equation:

$${T}_{J}^{low} = \frac{{A}_{J}^{low}}{{S}_{M}^{J}} + \frac{{B}_{J}^{low}}{{S}_{R}^{J}} + {C}_{J}^{low} . \qquad ( Eq . 3 )$$

The equation for T_{J}^{up} can be written in a similar form. The average (T_{J}^{avg}) of lower and upper bounds (average of T_{J}^{low} and T_{J}^{up}) can provide an approximation of the job completion time.

Once a technique for predicting the job completion time (using the performance model discussed above to compute an upper bound, lower bound, or intermediate of the completion time) is provided, it also can be used for solving the inverse problem: finding the appropriate number of map and reduce slots that can support a given job deadline D. For example, by setting the left side of Eq. 3 to deadline D, Eq. 4 is obtained with two variables S_{M}^{J} and S_{R}^{J}:

$$D = \frac{{A}_{J}^{low}}{{S}_{M}^{J}} + \frac{{B}_{J}^{low}}{{S}_{R}^{J}} + {C}_{J}^{low} \qquad ( Eq . 4 )$$

The foregoing describes a performance model for a single job. Note that a Pig program can have multiple jobs, some of which can execute concurrently. A job can be represented as a composition of non-overlapping map stage and reduce stage. There is effectively a barrier between a map stage and reduce stage of a job, in that any reduce task (corresponding to the reduce function) can start its execution only after all map tasks of the map stage have completed.

The following illustrates the difference between a performance model that assumes sequential execution of jobs as compared to an execution of jobs where overlap is allowed.

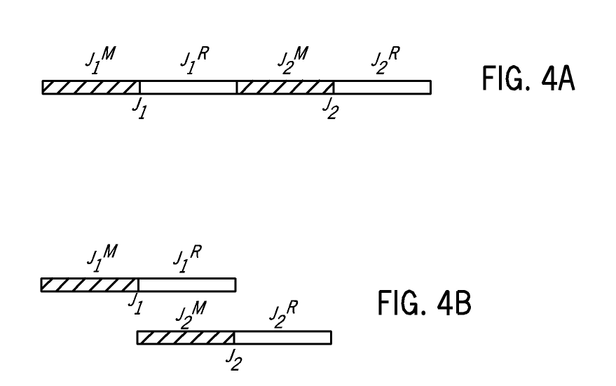

FIG. 4A depicts two jobs J₁ and J₂, that are executed sequentially (job J₂ is executed after job J₁). As depicted in FIG. 4A, job J₁ has a map stage (represented as J₁^{M}), and a reduce stage (represented as J₁^{R}). Similarly, job J₂ has a map stage (represented as J₂^{M}) and a reduce stage (represented as J₂^{R}). As can be seen, the sequential execution of jobs J₁ and J₂ results in the map stage J₂^{M} of job J₂ not starting until completion of the reduce stage J₁^{R} of job J₁.

If jobs J₁ and J₂ are assumed to be concurrent jobs, then there would be some overlap of jobs J₁ and J₂, as depicted in FIG. 4B. As seen in FIG. 4B, the map stage J₂^{M} of job J₂ can begin upon completion of the map stage J₁^{M} of job J₁, such that there is overlap in the reduce stage J₁^{R} of job J₁ and the map stage J₂^{M} of job J₂. It is noted that the map stage J₂^{M} of job J₂ can use the map resources (map slots) released upon completion of the map stage J₁^{M} of job J₁.

As can be seen from FIG. 4B, the overall execution time associated with concurrent execution of jobs J₁ and J₂ in FIG. 4B is less than the overall execution time in the sequential execution of jobs J₁ and J₂ in FIG. 4A. As noted above, a performance model developed for jobs of a Pig program can take into account the overlap of concurrent jobs, such as according to the example of FIG. 4B, to result in more optimal allocation of resources to the jobs of the Pig program using techniques or implementations according to some implementations.

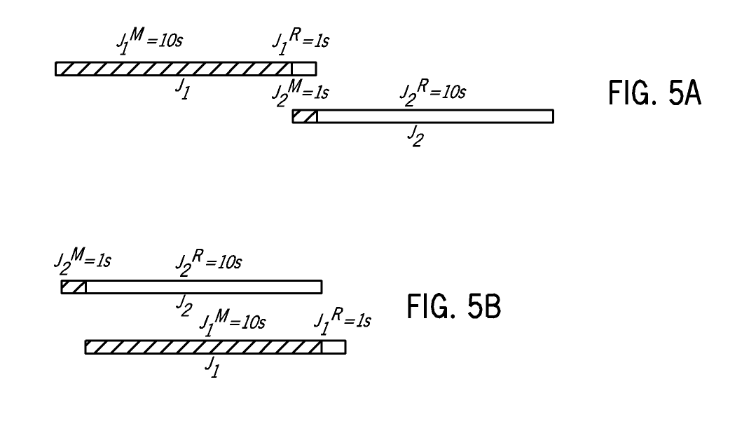

Given a subset of concurrent jobs of a Pig program, some techniques or mechanisms can select a random order of the concurrent jobs of the subset. This random order refers to an order of the jobs in the subset where one of the jobs is randomly selected to begin first, followed by another randomly selected job, followed by another randomly selected job, and so forth. In some cases, random ordering of concurrent jobs may lead to inefficient resource usage and increased execution time. An example of such a scenario is shown in FIG. 5A. In the example of FIG. 5A, it is assumed that the order of concurrent jobs is as follows: J₁ followed by J₂.

In the example of FIG. 5A, it is assumed that the map stage J₁^{M} of job J₁ takes 10 seconds to execute, and the reduce stage J₁^{R} of job J₁ takes one second to execute. It is also assumed that the map stage J₂^{M} of job J₂ takes one second to execute, while the reduce stage J₂^{R} of job J₂ takes 10 seconds to execute. The order of jobs depicted in FIG. 5A results in a longer overall execution time than the order of jobs depicted in FIG. 5B, where the order in FIG. 5B is as follows: job J₂ followed by job J₁.

In FIG. 5A, the maximum overlap of the reduce stage J₁^{R} of job J₁ and the map stage J₂^{M} of job J₂ is one second. On the other hand, in FIG. 5B, the maximum overlap of the reduce stage J₂^{R} of job J₂ and the map stage J₁^{M} of job J₁ is 10 seconds, much greater than the one-second overlap that is possible in FIG. 5A. As a result, the overall execution time of the J₁ and J₂ using the order of jobs in FIG. 5B is smaller than the overall execution time shown in FIG. 5A.

In accordance with some implementations, instead of using random ordering of concurrent jobs of a subset, an optimal schedule of concurrent jobs of the subset can be derived, and this optimal schedule of concurrent jobs is used by the performance model. In alternative implementations, rather than deriving an optimal schedule of concurrent jobs, an “improved” schedule of concurrent jobs can be derived, where an improved schedule of concurrent jobs refers to an order of concurrent jobs that has a smaller execution time (or improved performance parameter value) as compared to another order of concurrent jobs. A performance model based on an optimal or improved schedule of concurrent jobs can lead to computation of a smaller completion time, and thus more efficient allocation of resources.

In some implementations, the determination of the optimal or improved schedule can be accomplished using a brute-force technique, where multiple orders of jobs are considered and the order with the best or better execution time (smallest or smaller execution time) can be selected as the optimal or improved schedule.

In other implementations, another technique for identifying an optimal or improved schedule of concurrent jobs is to use the Johnson algorithm, such as described in S. Johnson, “Optimal Two- and Three-stage Production Schedules with Setup Times Included,” dated May 1953. The Johnson algorithm provides a decision rule to determine an optimal scheduling of tasks that are processed in two stages.

In other implementations, other techniques for determining an optimal or improved schedule of concurrent jobs can be employed.

Using the performance model of a single job as a building block, as described above, a performance model for the jobs of a Pig program P (which can be compiled into a collection of |P| jobs, P={J₁, J₂, . . . J_{|P|}}) can be derived, as discussed below.

For each job Jᵢ(1≦i≦|P|) that constitutes a program P, in addition to the number of map (N_{M}^{J}^{ᵢ}) and reduce (Nᵣ^{J}^{ᵢ}) tasks, metrics that reflect durations of map and reduce tasks (note that shuffle phase measurements can be included in reduce task measurements) can be derived:

(M_{avg}^{J}^{ᵢ},Mₘₐₓ^{J}^{ᵢ},AvgSize_{M}^{J}^{ᵢ}^{input},Selectivity_{M}^{J}^{ᵢ}),

(R_{avg}^{J}^{ᵢ},Rₘₐₓ^{J}^{ᵢ},Selectivity_{R}^{J}^{ᵢ}).

M_{avg}^{J}^{ᵢ} and Mₘₐₓ^{J}^{ᵢ} represent the average and maximum map task durations, respectively, for the job Jᵢ, and R_{avg}^{J}^{ᵢ} and Rₘₐₓ^{J}^{ᵢ} represent the average and maximum map reduce durations, respectively, for the job Jᵢ. AvgSize_{M}^{J}^{ᵢ}^{input} is the average amount of input data per map task of job Jᵢ (which is used to estimate the number of map tasks to be spawned for processing a dataset). Selectivity_{M}^{J}^{ᵢ} and Selectivity_{R}^{J}^{ᵢ} refer to the ratios of the map and reduce output sizes, respectively, to the map input size. Each of the parameters is used to estimate the amount of intermediate data produced by the map (or reduce) stage of job Jᵢ, which allows for the estimation of the size of the input dataset for the next job in the DAG.

The foregoing characteristics can be considered to be part of profiles for corresponding jobs. The profiles of jobs of a Pig program can be extracted (such as by the job profiler 120 of FIG. 1) based on past program execution.

As noted above, the jobs of a Pig program can be compiled into a DAG of jobs and includes S job stages (such as according to an example shown in FIG. 2). Note that due to data dependencies within a Pig execution plan, the next job stage cannot start until the previous job stage finishes. Let T_{S}_{ᵢ} denote the completion time of job stage Sᵢ. Thus, the completion of a Pig program P can be estimated as follows:

$${T}_{P} = {\sum }_{1 \leq i \leq S} {T}_{{S}_{i}} . \qquad ( Eq . 5 )$$

Eq. 5 specifies that the overall execution time of the Pig program P is equal to the sum of the execution times of the individual job stages Sᵢ, for i=1 to S. For a job stage Sᵢ that has a single job J, the stage completion time is defined by the job J's completion time.

For a job stage Sᵢ that has concurrent jobs, the stage completion time, T_{S}_{ᵢ}, depends on the jobs' execution order. Suppose there are |Sᵢ| jobs within a particular job stage Sᵢ and the jobs are executed according to the order {J₁, J₂, . . . J_{|S}_{ᵢ}_{|}}. Note, that given a number of allocated map/reduce slots (S_{M}^{P},S_{R}^{P}) to the Pig program P, techniques or mechanisms according to some implementations can compute, for any job Jᵢ(1≦i≦|Sᵢ|), the durations of the job's map and reduce stages. Such durations can be used in Johnson's algorithm to determine the optimal schedule of the jobs {J₁, J₂, . . . J_{|S}_{ᵢ}_{|}}.

For each job stage Sᵢ with concurrent jobs, the optimal job schedule that minimizes the completion time of the stage is determined, such as by use of Johnson's algorithm or of another technique. Next, a performance model for predicting the Pig program P's completion time T_{P} as a function of allocated resources (S_{M}^{P}, S_{R}^{P}) can be derived, as discussed in further detail below. The following notations can be used:

timeStart_{J}_{ᵢ}^{M}: the start time of job Jᵢ's map stage;

timeEnd_{J}_{ᵢ}^{M}: the end time of job Jᵢ's map stage;

timeStart_{J}_{ᵢ}^{R}: the start time of job Jᵢ's reduce stage;

timeEnd_{J}_{ᵢ}^{MR}: the end time of job Jᵢ's reduce stage.

Then the stage completion time (of a particular stage Sᵢ) can be estimated as

$${T}_{{S}_{i}} = {timeEnd}_{{J}_{\vert {S}_{i} \vert}}^{R} - {timeStart}_{{J}_{1}}^{M} . \qquad ( Eq . 6 )$$

The following explains how to estimate the start time and end time of each job's map stage and reduce stage.

Let T_{J}_{ᵢ}^{M} and T_{J}_{ᵢ}^{R} denote the completion times of map and reduce stages, respectively, of job Jᵢ. Then

timeEnd_{J}_{ᵢ}^{M}=timeStart_{J}_{ᵢ}^{M}+T_{J}_{ᵢ}^{M}, (Eq. 7)

timeEnd_{J}_{ᵢ}^{R}=timeStart_{J}_{ᵢ}^{R}+T_{J}_{ᵢ}^{R}. (Eq. 8)

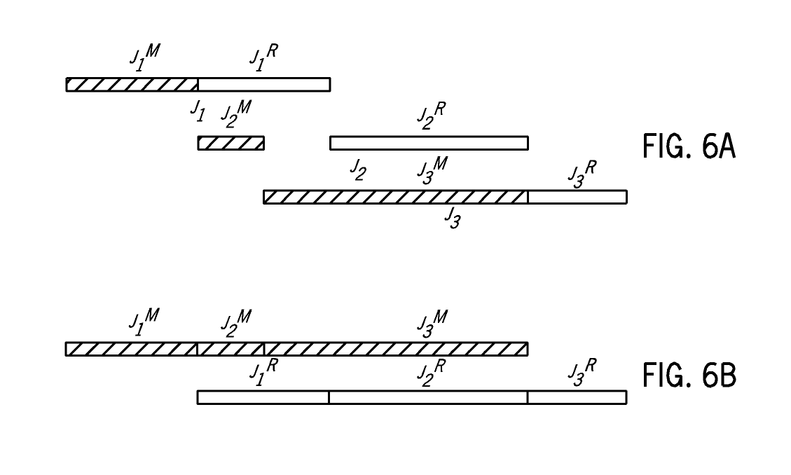

FIG. 6A shows examples of three concurrent jobs executed in the order J₁,J₂,J₃.

Note, that FIG. 6A can be rearranged to show the execution of the jobs' map and reduce stages separately, as depicted in FIG. 6B. From FIG. 6B, it can be seen that since all the concurrent jobs are independent, the map stage of the next job can start immediately once the previous job's map stage is finished. Accordingly, the start time of job Jᵢ's map stage can be computed based on the end time of the previous job, Jᵢ₋₁, as set forth below in Eq. 9.

timeStart_{J}_{ᵢ}^{M}=timeEnd_{J}_{ᵢ₋₁}^{M}=timeStart_{J}_{ᵢ₋₁}^{M}+T_{J}_{ᵢ₋₁}^{M} (Eq. 9)

The start time timeStart_{J}_{ᵢ}^{R} of the reduce stage of the concurrent job Jᵢ should satisfy the following two conditions:

1. timeStart_{J}_{ᵢ}^{R}≧timeEnd_{J}_{ᵢ}^{M},

2. timeStart_{J}_{ᵢ}^{R}≧timeEnd_{J}_{ᵢ₋₁}^{R}.

Therefore, the following equation is derived:

$$\begin{matrix}{timeStart}_{{J}_{i}}^{R} = max \{ {timeEnd}_{{J}_{i}}^{M} , {timeEnd}_{{J}_{i - 1}}^{R} \} = \\ = max \{ \begin{matrix}{timeStart}_{{J}_{i}}^{M} + {T}_{{J}_{i}}^{M} , \\ {timeStart}_{{J}_{i - 1}}^{R} + {T}_{{J}_{i - 1}}^{R}\end{matrix} \}\end{matrix} \qquad ( Eq . 10 )$$

Finally, the completion time of the entire Pig program P is defined as the sum of the job stages making up the program, according to Eq. 5.

Given the performance model for the jobs of a Pig program P, as discussed above, the challenge is then to compute an allocation of resources (e.g. map slots and reduce slots), given that the Pig program P has a deadline D. The optimized execution of concurrent jobs in P may improve the program completion time. Therefore, P can be assigned a smaller amount of resources for meeting the deadline D compared to its non-optimized execution (where jobs are assumed to executed sequentially).

The following describes how to approximate the resource allocation of a non-optimized execution of a Pig program (which assumes sequential execution of the jobs in the various job stages of the program). The completion time of non-optimized execution of the program P can be represented as a sum of completion times of the jobs that make up the DAG of the program. Thus, for a Pig program P that contains |P| jobs, its completion time can be estimated as a function of assigned map and reduce slots (S_{M}^{P},S_{R}^{P}) as follows:

$${T}_{P} ( {S}_{M}^{P} , {S}_{R}^{P} ) = {\sum }_{1 \leq i \leq \vert P \vert} {T}_{{J}_{i}} ( {S}_{M}^{P} , {S}_{R}^{P} ) . \qquad ( Eq . 11 )$$

Using the performance model based on Eq. 11, the completion time D of the Pig program P can be expressed using Eq. 12 below, which is similar to Eq. 3:

$$D = \frac{{A}^{P}}{{S}_{M}^{P}} + \frac{{A}^{P}}{{S}_{R}^{P}} + {C}^{P} . \qquad ( Eq . 12 )$$

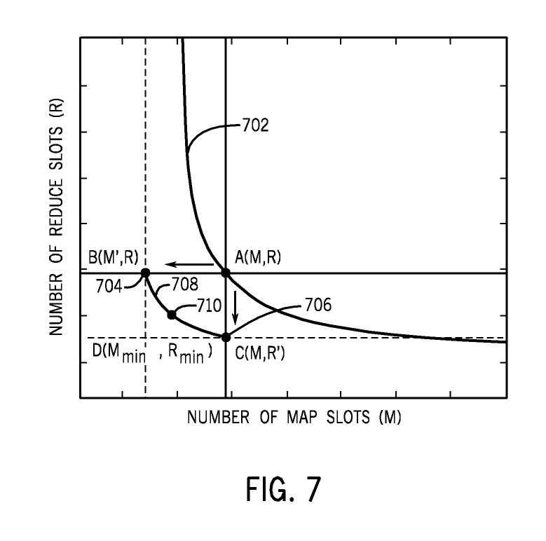

Eq. 12 can be used for solving the inverse problem of finding resource allocations (S_{M}^{P}, S_{R}^{P}) such that the program P completes within time D. As can be seen in FIG. 7, Eq. 12 yields a curve 702 (e.g. a hyperbola) if S_{M}^{P}, S_{R}^{P} (number of map slots and number of reduce slots, respectively) are considered as variables. All points on this curve 702 are feasible allocations of map and reduce slots for program P which result in meeting the same deadline D. As shown in FIG. 7, allocations can include a relatively large number of map slots and very few reduce slots, or very few map slots and a large number of reduce slots, or somewhere in between.

These different feasible resource allocations (represented by points along the curve 702) correspond to different amounts of resources that allow the deadline D to be satisfied. Finding an optimal allocation of resources along the curve 702 can be accomplished by by using a Lagrange's multiplier technique, as described further in U.S. patent application Ser. No. 13/442,358, entitled “DETERMINING AN ALLOCATION OF RESOURCES TO ASSIGN TO JOBS OF A PROGRAM,” filed Apr. 9, 2012. The Langrange's multiplier technique can identify the point, A(M,R), on the curve 702, where A (M,R) represents the point with a minimal number of map and reduce slots (i.e. the pair (M,R) results in the minimal sum of map and reduce slots).

However, the performance model based on Eq. 10 (discussed above) that can be used for more accurate completion time estimates for optimized Pig program execution (where overlap of concurrent jobs is allowed) is more complex. As seen in Eq. 10, a max (maximum) function is computed for job stages with concurrent jobs. However, in accordance with some implementations, determining an optimal allocation of resources given a performance model based on Eq. 10 can use the “over-provisioned” resource allocation defined by Eq. 12 as an initial point for determining the solution for an optimized execution of the Pig program P.

Techniques or mechanisms according to some implementations can use the curve 702 of FIG. 7 that has the point A(M,R), which represents the point with a minimal number of map and reduce slots that make up the optimal resource allocation for the “over-provisioned” case. In accordance with some implementations, the optimal resource allocation determined using a performance model that allows considers concurrent execution (overlap) of concurrent jobs is represented as (Mₘᵢₙ, Rₘᵢₙ), which indicates the minimal number of map slots and minimal number of reduce slots to be assigned to allow an optimized Pig program P to meet deadline D.

In some examples, the following pseudocode can be used to solve for (Mₘᵢₙ,Rₘᵢₙ):

Pseudocode Determining the resource allocation for a pig program

| | Input: Job profiles of all the jobs in P = {J₁,J₂,...J_{\|S}_{ᵢ}_{\|}} |
|---|---|
| | D ← a given deadline |
| | (M, R) ← the minimum pair of map and reduce slots obtained |
| | for P and deadline D by applying the basic performance model that assumes sequential |
| | execution of jobs of P |
| | Optimal execution of jobs J₁,J₂,...J_{\|S}_{ᵢ}_{\|} based on (M, R) |
| | Output: Resource allocation pair (Mₘᵢₙ, Rₘᵢₙ) for optimized P |
| 1: | M′ ← M, R′ ← R |
| 2: | while T_{P}^{avg} (M′, R) ≦ D do // From A to B |
| 3: | M′ [symbol] M′ − 1 |
| 4: | end while |
| 5: | while T_{P}^{avg} (M, R′) ≦ D do // From A to C |
| 6: | R′ [symbol] R′ − 1, |
| 7: | end while |
| 8: | Mₘᵢₙ ← M, Rₘᵢₙ ← R, Min ← (M + R) |
| 9: | for \hat{M} ← M′ + 1to M do // Explore curve B to C |
| 10: | \hat{R} = R − 1 |
| 11: | while T_{P}^{avg} (\hat{M}, \hat{R}) ≦ D do |
| 12: | \hat{R} [symbol] \hat{R} − 1 |
| 13: | end while |
| 14: | if \hat{M} + \hat{R} < Min then |
| 15: | Mₘᵢₙ [symbol] \hat{M}, Rₘᵢₙ [symbol] \hat{R}, Min ← (\hat{M} + \hat{R}) |
| 16: | end if |
| 17: | end for |

The following discusses the tasks performed by the pseudocode set forth above. First, the pseudocode finds the minimal number of map slots M′ (i.e. the pair (M′, R) at point 704 in FIG. 7) such that deadline D can still be met by the Pig program (in which overlap of concurrent jobs is allowed). Finding M′ can be accomplished by fixing the number of reduce slots to R, and then step-by-step reducing the allocation of map slots. Specifically, the pseudocode sets the resource allocation to (M−1, R) and checks whether program P can still be completed within time D (T_{P}^{avg}, average of T_{P}^{up} and T_{P}^{low} computed for Eq. 5 that assumes upper and lower bounds, respectively, for execution times of map and reduce stages, can be used for completion time estimates). If the answer is positive, then the pseudocode tries (M−2,R) as the next allocation. This process continues until point B (M′, R) (704 in FIG. 7) is found such that the number M′ of map slots cannot be further reduced for meeting a given deadline D (lines 1-4 of the pseudocode). Note that this determination uses the performance model that considers overlap of concurrent jobs.

In the second step, the pseudocode applies a similar process for finding the minimal number of reduce slots R′ (i.e. the pair (M, R′) of point 706 in FIG. 7) such that the deadline D can still be met by the optimized execution of the Pig program P (lines 5-7 of the pseudocode), again using the performance model that considers overlap of concurrent jobs.

In the third step, the pseudocode determines the intermediate values on a curve 708 between (M′,R) and (M,R′), points B and C, respectively, such that deadline D is met by the optimized Pig program P (using the performance model that considers overlap of concurrent jobs). Starting from point (M′,R), the pseudocode tries to find the allocation of map slots from M′ to M, such that the minimal number of reduce slots \hat{R} should be assigned to P for meeting its deadline (lines 10-12 of the pseudocode).

Next, the solution (Mₘᵢₙ,Rₘᵢₙ) (point 710 in FIG. 7) represents the pair of a number of map slots and a number of reduce slots on the curve 708 such that the minimal sum of map and reduce slots results (solution found at lines 14-17 of the pseudocode) that still allows for the deadline D of the program to be met.

Although a specific pseudocode is depicted above, it is noted that in alternative examples, other techniques or mechanisms can be used to find a resource allocation for a program, such as a Pig program, that meets a given deadline of the program, where a performance model is used that considers overlap of concurrent jobs.

Various techniques discussed above, such as techniques depicted in FIG. 3 or 7 or in the pseudocode, can be implemented with modules (such as those depicted in FIG. 1) that can include machine-readable instructions. The machine-readable instructions are executable on at least one processor (such as 124 in FIG. 1). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
generating, by a system having a processor, a collection of jobs corresponding to a program, wherein the jobs include map tasks and reduce tasks, the map tasks producing intermediate results based on segments of input data, and the reduce tasks producing an output based on the intermediate results;
calculating, in the system, a performance parameter using a performance model based on a number of the map tasks in the jobs, a number of reduce tasks in the jobs, and an allocation of resources, where the performance model considers overlap in execution of concurrent jobs; and
determining, by the system using a value of the performance parameter calculated by the performance model, a particular allocation of resources to assign to the jobs of the program to meet a performance goal of the program.

2. The method of claim 1, further comprising:
identifying a plurality of job stages for the program, wherein the concurrent jobs are in at least a given one of the plurality of job stages.

3. The method of claim 2, further comprising:
determining, for the given job stage, a first order of the concurrent jobs that has an improved performance with respect to a second order of the concurrent jobs,
wherein the performance model uses the first order of the concurrent jobs.

4. The method of claim 2, wherein generating the collection of jobs comprises generating a directed acyclic graph of the jobs, the plurality of jobs identified by the directed acyclic graph.

5. The method of claim 1, wherein the overlap in the execution of the concurrent jobs comprises an overlap of a reduce stage of a first of the concurrent jobs and a map stage of a second of the concurrent jobs.

6. The method of claim 1, wherein the performance model calculates the performance parameter based on aggregating performance parameters of corresponding individual stages associated with the progress, where at least one of the stages includes the concurrent jobs, and wherein determining the particular allocation of resources comprises determining a number of resources to be used by each of the jobs of the collection.

7. The method of claim 1, wherein the performance goal is a completion time, and wherein the performance parameter is a time parameter.

8. The method of claim 1, wherein the performance parameter calculated by the performance model is one of a lower bound parameter, an upper bound parameter, and an intermediate parameter between the lower bound parameter and the upper bound parameter.

9. The method of claim 1, wherein generating the collection of jobs from the program comprise generating the collection of jobs from a Pig program.

10. The method of claim 1, wherein determining the particular allocation of resources comprises determining a number of map slots and a number of reduce slots, the map slots to perform map tasks, and reduce slots to perform reduce tasks.

11. An article comprising at least one machine-readable storage medium storing instructions that upon execution cause a system to:
compile, from a program, a collection of jobs, wherein the jobs include map tasks and reduce tasks, the map tasks producing intermediate results based on segments of input data, and the reduce tasks producing an output based on the intermediate results;
provide a first performance model to calculate a performance parameter based on characteristics of the jobs, a number of the map tasks in the jobs, a number of reduce tasks in the jobs, and an allocation of resources, where the first performance model considers overlap in execution of concurrent jobs; and
determine, using a value of the performance parameter calculated by the first performance model, a particular allocation of resources to assign to the jobs of the program to meet a performance goal of the program.

12. The article of claim 11, wherein the particular allocation of resources comprises a number of map slots and a number of reduce slots to be used by each of the jobs in the collection.

13. The article of claim 11, wherein determining the particular allocation of resources comprises:
identifying feasible allocations of the resources that meet the performance goal of the program, where the identifying is based on a second performance model that assumes sequential execution of the jobs in the collection; and
using the identified feasible allocations to iteratively reduce an amount of the resources until the particular allocation of resources is determined.

14. The article of claim 11, wherein the performance parameter is based on a number of map tasks and durations of map tasks of each of the jobs, and on a number of reduce tasks and durations of reduce tasks of each of the jobs.

15. The article of claim 11, wherein the instructions upon execution cause the system to further:
determine a first order of the concurrent jobs that has an improved performance with respect to a second order of the concurrent jobs,
wherein the first performance model uses the first order of the concurrent jobs.

16. The article of claim 11, wherein the overlap in the execution of the concurrent jobs comprises an overlap of a reduce stage of a first of the concurrent jobs and a map stage of a second of the concurrent jobs.

17. The article of claim 11, wherein the performance goal is a completion time, and wherein the performance parameter is a time parameter.

18. A system comprising:
worker nodes having resources; and
a resource allocator to:
use a performance model to calculate a performance parameter based on characteristics of a collection of jobs that make up a program, a number of map tasks in the jobs, a number of reduce tasks in the jobs, and an allocation of resources, wherein the jobs include the map tasks and the reduce tasks, the map tasks producing intermediate results based on segments of input data, and the reduce tasks producing an output based on the intermediate results, and where the performance model considers overlap in execution of concurrent jobs; and
determine, using a value of the performance parameter calculated by the performance model, a particular allocation of resources to assign to the jobs of the program to meet a performance goal of the program.

19. The system of claim 18, wherein the resource allocator is to further:
determine a first order of the concurrent jobs that has a smaller overall execution time than an overall execution time of a second order of the concurrent jobs,
wherein the performance model uses the first order of the concurrent jobs instead of the second order of the concurrent jobs.

20. The system of claim 19, wherein the overlap in the execution of the concurrent jobs comprises an overlap of a reduce stage of a first of the concurrent jobs and a map stage of a second of the concurrent jobs.
